(19) United States
(12) Patent Application Publication
(10) Pub. No.: US 2024/0420050 A1
(43) Pub. Date: Dec. 19, 2024

(54) METHODS AND INTERNET OF THINGS SYSTEMS FOR GAS DEMAND INFORMATION MANAGEMENT BASED ON SMART GAS

(71) Applicant: CHENGDU QINCHUAN IOT TECHNOLOGY CO., LTD., Chengdu (CN)

(72) Inventors: Zehua SHAO, Chengdu (CN); Yaqiang QUAN, Chengdu (CN); Yong LI, Chengdu (CN); Guanghua HUANG, Chengdu (CN)

(73) Assignee: CHENGDU QINCHUAN IOT TECHNOLOGY CO., LTD., Chengdu (CN)

(21) Appl. No.: 18/822,261

(22) Filed: Sep. 1, 2024

(30) Foreign Application Priority Data
Jul. 1, 2024 (CN) 202410868374.9

(51) Int. Cl. G06Q 10/0631; G06Q 50/06; G16Y 10/35; G16Y 40/10

(52) U.S. Cl. CPC G06Q 10/06315; G06Q 50/06; G16Y 10/35; G16Y 40/10

(57) ABSTRACT

Example embodiments of the present disclosure provide a method and an Internet of Things system for gas demand information management based on smart gas. The method includes obtaining gas monitoring data from a plurality of channels; obtaining estimated demand data of a gas enterprise; and generating a monitoring adjustment instruction and a data export instruction based on the gas monitoring data and the estimated demand data; sending the data export instruction to the gas monitoring device corresponding to the at least one channel based on the gas user object platform, the gas equipment object platform, and/or the gas user platform; and causing the gas monitoring device corresponding to the at least one channel to export, based on the data export instruction, the flow log file from a log storage unit to the gas user object platform, the gas equipment object platform, and/or the gas user platform.

### CROSS-REFERENCE TO RELATED APPLICATIONS

This application claims priority to Chinese Patent Application No. 202410868374.9, filed on Jul. 1, 2024, the entire contents of which are hereby incorporated by reference.

### TECHNICAL FIELD

The present disclosure relates to the field of smart gas technology, and in particular, to methods and Internet of Things systems for gas demand information management based on smart gas.

### BACKGROUND

The gas enterprise, when performing management of gas business, monitors gas consumption of gas usage enterprises and evaluates the gas demand of the gas enterprise by counting data uploaded by a gas monitoring device on a gas pipeline network or data reported by the gas usage enterprises. However, due to the measurement error of the data acquired by different gas monitoring devices at different locations, and the mismatch between the gas demand reported by gas usage enterprises and the actual gas usage, the accuracy of gas demand prediction needs to be further improved.

Therefore, it is desirable to provide a method and an Internet of Things system for gas demand information management based on smart gas, to recognize and filter reliable gas demand data and improve the accuracy of the gas demand prediction.

### SUMMARY

One or more embodiments of the present disclosure provide a method for gas demand information management based on smart gas, implemented by an Internet of Things (IoT) system for gas demand information management based on smart gas. The IoT system for gas demand information management based on the smart gas may include a gas user platform, a gas user service platform, a gas company management platform, a gas user object platform, and a gas equipment object platform. The method may be executed by the gas company management platform. The method may include obtaining gas monitoring data from a plurality of channels based on the gas user platform, the gas user object platform, and the gas equipment object platform; obtaining estimated demand data of a gas enterprise based on the gas user platform, the estimated demand data including a plurality of future time periods and estimated demands corresponding to the plurality of future time periods; generating a monitoring adjustment instruction and a data export instruction based on the gas monitoring data and the estimated demand data, and sending the monitoring adjustment instruction and the data export instruction to the gas user platform, the gas user object platform, and the gas equipment object platform, the monitoring adjustment instruction including upload frequencies and upload priorities of gas monitoring data of the plurality of channels, and the data export instruction including a at least one channel and a flow log file of a gas monitoring device corresponding to the at least one channel; sending the data export instruction to the gas monitoring device corresponding to the at least one channel based on the gas user object platform, the gas equipment object platform, and/or the gas user platform; and causing the gas monitoring device corresponding to the at least one channel to export, based on the data export instruction, the flow log file from a log storage unit to the gas user object platform, the gas equipment object platform, and/or the gas user platform.

One or more embodiments of embodiments of the present disclosure provide an IoT system for gas demand information management based on smart gas. The system may include a gas user platform, a gas user service platform, a gas company management platform, a gas user object platform, and a gas equipment object platform. The gas user platform may interact with the gas user service platform bi-directionally, and the gas user service platform may interact with the gas company management platform bi-directionally. The gas user platform may be configured to obtain gas monitoring data from a plurality of channels and estimated demand data from a gas enterprise. The estimated demand data may include a plurality of future time periods and estimated demands corresponding to the plurality of future time periods. The gas user object platform and the gas equipment object platform may be configured to obtain the gas monitoring data from the plurality of channels. The gas user object platform, the gas equipment object platform, and/or the gas user platform may be further configured to send a data export instruction to a gas monitoring device corresponding to at least one channel and receive a flow log file of the monitoring device corresponding to the at least one channel. The gas company management platform may be configured to generate a monitoring adjustment instruction and the data export instruction based on the gas monitoring data and the estimated demand data, and send the monitoring adjustment instruction and the data export instruction to the gas user platform, the gas user object platform and the gas equipment object platform; and in response to the gas monitoring device corresponding to the at least one channel receiving the data export instruction, cause the gas monitoring device to export, based on the data export instruction, the flow log file from a log storage unit to the gas user object platform, the gas equipment object platform, and/or the gas user platform. The monitoring adjustment instruction may include upload frequencies and upload priorities of gas monitoring data of the plurality of channels, and the data export instruction may include at least one channel and the flow log file of the gas monitoring device corresponding to the at least one channel.

One or more embodiments of the present disclosure provide a device for gas demand information management based on smart gas, and the device may include at least one memory and at least one processor. The at least one memory may be configured to store computer instructions, and the at least one processor may execute the computer instructions or part of the computer instructions to implement the method for gas demand information management based on smart gas.

One or more embodiments of the present disclosure provide a non-transitory computer-readable storage medium storing computer instructions. When a computer reads the computer instructions in the storage medium, the computer may perform the method for gas demand information management based on smart gas.

In one or more embodiments of the present disclosure, through the IoT system for gas demand information management based on smart gas, a closed loop of information operation may be formed between multiple platforms, realizing the informatization and intellectualization of gas demand information management. Through the gas monitoring data and estimated demand data, whether the channel is abnormal may be determined, and the feedback of the gas monitoring data may be dynamically adjusted according to the abnormality, reducing the interference of abnormal data on the data analysis, realizing identification and filtering of reliable gas demand data, improving the accuracy of the gas demand prediction, and ensuring the normal operation of the gas pipeline network.

### BRIEF DESCRIPTION OF THE DRAWINGS

the present disclosure will be further illustrated by way of exemplary embodiments, which will be described in detail by means of the accompanying drawings. These embodiments are not limiting, and in these embodiments, the same numbering denotes the same structure, wherein:

FIG. 1 is a schematic diagram illustrating an Internet of Things system for gas demand information management based on smart gas according to some embodiments of the present disclosure;

FIG. 2 is an exemplary flowchart illustrating an exemplary method for gas demand information management based on smart gas according to some embodiments of the present disclosure;

FIG. 3 is an exemplary flowchart illustrating an exemplary process of adjusting a metering parameter according to some embodiments of the present disclosure;

FIG. 4 is an exemplary schematic diagram illustrating a first predictive model according to some embodiments of the present disclosure;

FIG. 5 is an exemplary schematic diagram illustrating generating a monitoring adjustment instruction according to some embodiments of the present disclosure; and

FIG. 6 is a schematic diagram illustrating an exemplary second predictive model according to some embodiments of the present disclosure.

### DETAILED DESCRIPTION

To more clearly illustrate the technical solutions related to the embodiments of the present disclosure, a brief introduction of the drawings referred to the description of the embodiments is provided below. Obviously, the drawings described below are only some examples or embodiments of the present disclosure. Those having ordinary skills in the art, without further creative efforts, may apply the present disclosure to other similar scenarios according to these drawings. Unless obviously obtained from the context or the context illustrates otherwise, the same numeral in the drawings refers to the same structure or operation.

It should be understood that “system,” “device”, “unit” and/or “module” as used herein is a manner used to distinguish different components, elements, parts, sections, or assemblies at different levels. However, if other words serve the same purpose, the words may be replaced by other expressions.

As shown in the present disclosure and claims, the words “one”, “a”, “a kind” and/or “the” are not especially singular but may include the plural unless the context expressly suggests otherwise. In general, the terms “comprise”, “comprises”, “comprising”, “include”, “includes”, and/or “including”, merely prompt to include operations and elements that have been clearly identified, and these operations and elements do not constitute an exclusive listing. The methods or devices may also include other operations or elements.

The flowcharts used in the present disclosure illustrate operations that systems implement according to some embodiments of the present disclosure. It should be understood that the previous or subsequent operations may not be accurately implemented in order. Instead, each step may be processed in reverse order or simultaneously. Meanwhile, other operations may also be added to these processes, or a certain step or several steps may be removed from these processes.

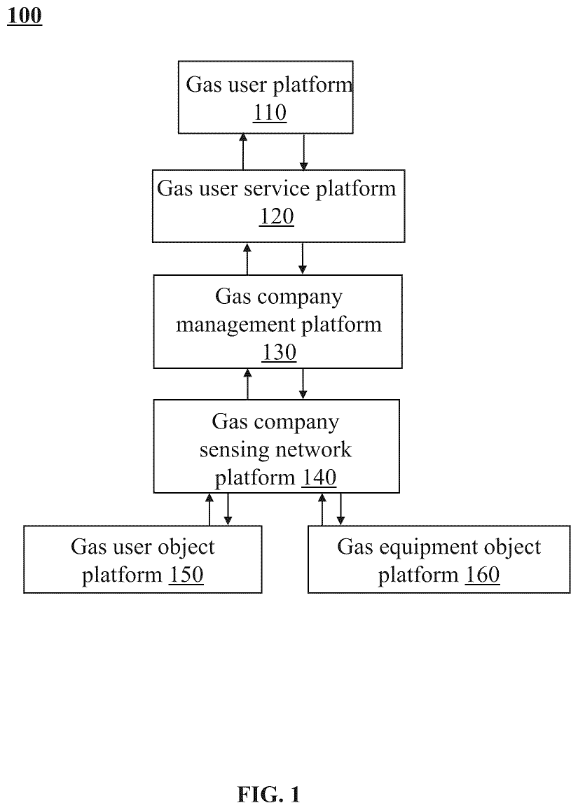

FIG. 1 is a schematic diagram illustrating an Internet of Things (IoT) system for gas demand information management based on smart gas according to some embodiments of the present disclosure.

In some embodiments, an IoT system for gas demand information management based on smart gas 100 (referred to as the IoT system 100 hereinafter) may include a gas user platform 110, a gas user service platform 120, a gas company management platform 130, a gas user object platform 150, and a gas equipment object platform 160.

The gas user platform 110 refers to a platform for interacting with a user. In some embodiments, the gas user platform 110 may be configured as a terminal device. For example, the gas user platform 110 may be a smartphone, a tablet computer, a laptop computer, etc., or any combination thereof.

In some embodiments, the gas user platform 110 may be configured to obtain gas monitoring data from a plurality of sources and estimated demand data from a gas enterprise.

The gas user service platform 120 refers to a platform configured to provide the user with gas inquiry, gas supervision, and other related user services. In some embodiments, the gas user service platform may be arranged in a centralized manner. The centralized arrangement means that the receiving, processing, and sending of data and/or information are unified by a platform.

In some embodiments, the gas user platform 110 may interact with the gas user service platform 120 bi-directionally. For example, the gas user service platform 120 may provide services such as gas operation, gas supervision, or the like, to the gas user platform 110 through information such as the gas monitoring data provided by the gas user platform 110.

In some embodiments, the gas user service platform 120 may with the gas company management platform 130 interact bi-directionally. For example, the gas user service platform 120 may obtain a monitoring adjustment instruction and a data export instruction, etc., from the gas company management platform 130.

The gas company management platform 130 refers to a platform for performing gas demand information management for smart gas. In some embodiments, the gas company management platform 130 may coordinate and harmonize connection and collaboration between other platforms of the IoT system for gas demand information management based on smart gas, and aggregates all the information of the IoT, providing perception management and control management functions for an IoT operation system.

In some embodiments, the gas company management platform 130 may have a freestanding arrangement. The gas company management platform 130 may include a plurality of management sub-platforms, each of which operates independently for managing information in a corresponding region.

In some embodiments, the gas company management platform 130 may be configured to generate the monitoring adjustment instruction and the data export instruction based on the gas monitoring data and the estimated demand data and send the monitoring adjustment instruction and the data export instruction to the gas user platform 110, the gas user object platform 150, and the gas equipment object platform 160. In response to at least one of the channels corresponding to the gas monitoring device receiving the data export instruction, the gas company management platform 130 may be configured to cause the gas monitoring device to export a flow log file, based on the data export instruction, from the log storage unit, to the gas user object platform 150, the gas equipment object platform 160, and/or the gas user platform 110.

In some embodiments, the gas company management platform 130 may be configured to determine gas correction data and an allowable fluctuation range based on the gas monitoring data. The gas company management platform 130 may be configured to determine an anomalous channel based on the gas monitoring data, the allowable fluctuation range, the gas pressure, and the gas temperature. The gas company management platform 130 may be configured to determine a margin of error of the anomalous channel based on the gas monitoring data and the gas correction data. The gas company management platform 130 may also be configured to generate an error correction instruction corresponding to each anomalous channel and send it to the gas user object platform 150, the gas equipment object platform 160, and/or the gas user platform 110, respectively based on the margin of error, the gas pressure, and the gas temperature. The gas company management platform 130 may further be configured to in response to receiving the error correction instruction from the target channel, cause the target channel corresponding gas monitoring device to automatically adjust a metering parameter based on the error correction instruction.

In some embodiments, the gas company management platform 130 may also be configured to determine, based on the gas monitoring data, a grouping of the gas monitoring data of the plurality of channels through a first predictive model; and determine the gas correction data based on the grouping.

In some embodiments, the gas company management platform 130 may also be configured to determine an accuracy distribution based on the gas monitoring data and the estimated demand data and generate the monitoring adjustment instruction based on the accuracy distribution.

In some embodiments, the gas company management platform 130 may also be configured to determine gas future data based on the gas correction data and determine the accuracy distribution based on the estimated demand data and the gas future data.

In some embodiments, the gas company management platform 130 may be configured to determine first future data based on the gas correction data via a second predictive model.

In some embodiments, the gas company management platform 130 may interact upwardly with the gas user service platform 120. The gas company management platform 130 may also interact downwardly with a gas company sensing network platform 140. For example, the gas company management platform 130 may send the monitoring adjustment instruction and the data export instruction to the gas company sensing network platform 140, and receive the gas monitoring data uploaded from the gas company sensing network platform 140.

In some embodiments, the IoT system 100 may include the gas company sensing network platform 140.

The gas company sensing network platform 140 refers to a platform for obtaining relevant communication data. In some embodiments, the gas company sensing network platform 140 may be configured as a communications network and gateway. In some embodiments, the gas company sensing network platform 140 may function as a sensing communication for sensing information and a sensing communication for controlling information.

In some embodiments, the gas company sensing network platform 140 may have a freestanding arrangement. The gas company sensing network platform 140 may include a plurality of sensing sub-network platforms, each of which is independently operated and one-to-one with the management sub-platforms for realizing communication between the corresponding management sub-platform and the gas user object platform 150 and the gas equipment object platform 160 in each of the corresponding regions.

In some embodiments, the gas user object platform 150 and the gas equipment object platform 160 interact bi-directionally with the gas company management platform 130 via the gas company sensing network platform 140. That is, the gas company sensing network platform 140 may interact upwardly with the gas company management platform 130, and the gas company sensing network platform 140 may also interact downwardly with the gas user object platform 150 and the gas equipment object platform 160. For example, the gas user object platform 150 transmits an exported flow log file to the gas company management platform 130 via the gas company sensing network platform 140. As another example, the gas equipment object platform 160 may receive the monitoring adjustment instruction and the data export instruction, etc., issued by the gas company management platform 130 via the gas company sensing network platform 140.

The gas user object platform 150 refers to a platform for obtaining monitoring data related to the user. In some embodiments, the gas user object platform 150 may be configured as various types of devices, including various types of sensors, gas flow meters, gas meters, or the like, used by gas users (e.g., the gas enterprise, etc.).

The gas equipment object platform 160 refers to a platform for obtaining monitoring data related to devices. In some embodiments, the gas equipment object platform 160 may be configured as various types of equipment, including various types of sensors in a gas pipeline, gas flow meters, gas meters, or the like.

In some embodiments, the gas user object platform 150 and the gas equipment object platform 160 may be configured to obtain the gas monitoring data from the plurality of channels.

In some embodiments, the gas user object platform 150 and the gas equipment object platform 160 may be further configured to send the data export instruction to a gas monitoring device corresponding to at least one channel and to receive a flow log file of the gas monitoring device corresponding to the at least one channel.

In some embodiments, the gas user object platform 150, and the gas equipment object platform 160 and/or the gas user platform 110 may receive the error correction instruction corresponding to the anomalous channel sent by the gas company management platform 130, and in response to determining that the error correction instruction is to correct the metering parameter, send the error instruction to a target channel.

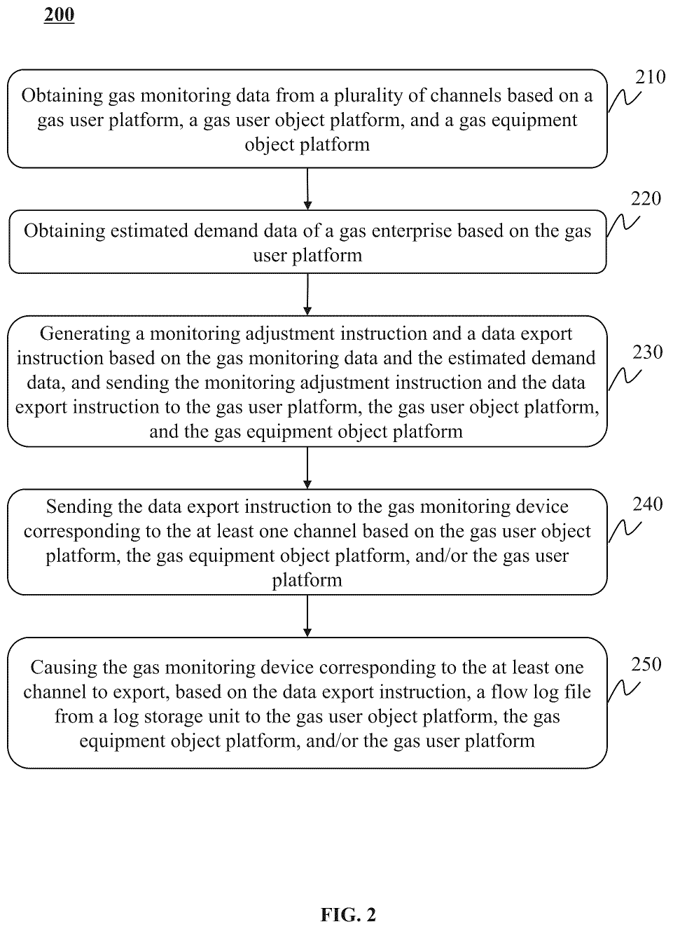

More descriptions regarding each of the above platforms may be found in FIG. 2-FIG. 6 and related descriptions thereof.

In some embodiments of the present disclosure, the IoT system for gas demand information management based on the smart gas may form a closed loop of information operation between the gas equipment object platform, the gas user object platform, the gas company management platform, the gas company sensing network platform, the gas user service platform, and the gas user platform, and coordinate and operate regularly under the unified management of the gas company management platform, realizing informatization and intellectualization of the gas demand information management of the smart gas.

It should be noted that the above description of the IoT system 100 and its modules is provided only for descriptive convenience, and does not limit the present disclosure to the scope of the cited embodiments. It is to be understood that for a person skilled in the art, after understanding the principle of the system, it may be possible to arbitrarily combine individual modules or form a subsystem to connect with other modules without departing from this principle. In some embodiments, the gas user platform 110, the gas user service platform 120, the gas company management platform 130, the gas company sensing network platform 140, the gas user object platform 150 and the gas equipment object platform 160 may be different modules in a single system, or a single module realizing the functions of two or more of the above-described modules. For example, the individual modules may share a common storage module, and the individual modules may each have a respective storage module. Morphisms such as these are within the scope of protection of the present disclosure.

FIG. 2 is an exemplary flowchart illustrating an exemplary method for gas demand information management based on smart gas according to some embodiments of the present disclosure. As shown in FIG. 2, the process 200 includes the following steps. In some embodiments, the process 200 may be realized by IoT system 100 (e.g., performed by the gas company management platform 130).

For the sake of illustration, the gas company management platform 130 in the present disclosure may be referred to as the management platform hereinafter.

In 210, based on the gas user platform, the gas user object platform, and the gas equipment object platform, gas monitoring data from a plurality of channels is obtained.

A channel refers to a source from which the gas monitoring data is obtained. In some embodiments, different channels may correspond to different gas monitoring devices, and corresponding gas monitoring data may be obtained from different channels.

The gas monitoring device refers to a device that monitors gas-related conditions. For example, a gas monitoring device may include a gas flow meter, a gas meter, or the like.

The gas monitoring data refers to monitoring acquired data related to gas usage. In some embodiments, the gas monitoring data may include gas usage for a plurality of historical time periods.

The historical time period refers to a past time period. In some embodiments, each of the plurality of historical time periods is of the same length. The length and number of historical time periods may be manually preset or set by default by the system. For example, the length of the history time period may be 24 hours and the number may be 30, i.e., the plurality of history time periods may be every day in the past month.

The gas usage refers to a statistical amount of gas actually used by the user. For example, the gas usage may be 450,000 cubic meters, 500,000 cubic meters, etc.

In some embodiments, the gas monitoring data may be represented by a sequence including gas usage for the plurality of historical time periods. For example, the gas monitoring data may be {50, 41, 47, 53, . . . }, indicating that a monitored gas usage for historical time period 1 is 500,000 cubic meters, a monitored gas usage for historical time period 2 was 410,000 cubic meters, and so on.

In some embodiments, the management platform may obtain the gas monitoring data in a variety of ways based on the gas user platform, the gas user object platform, and the gas equipment object platform. For example, the management platform may obtain the gas usage recorded by a gas meter of an industrial user based on the gas user object platform. As another example, the management platform may obtain, based on the gas equipment object platform, the gas usage recorded by a gas meter in a gas pipeline. As yet another example, the management platform may obtain, based on the gas user platform, the gas usage counted by the gas enterprise.

The gas enterprise refers to a business that uses gas. For example, the gas enterprise may be a manufacturing plant, a farming base, a warehouse plant, etc.

In some embodiments, a platform may correspond to a plurality of channels, i.e., each platform (including the gas user platform, the gas user object platform, and the gas equipment object platform) may access the gas monitoring data from the plurality of channels.

For example, gas monitoring data of a manufacturing plant obtained by the management platform through the gas user object platform may come from the plurality of channels. Channel A may be a main gas meter of the gas enterprise, channel B may be a branch gas meter corresponding to each region of the gas enterprise, and channel C may be a unit gas meter corresponding to each device of the gas enterprise.

The gas monitoring data of the gas enterprise may be obtained directly through the channel A. The gas monitoring data of gas enterprise may be obtained by summing up through the channel B. The gas monitoring data of the gas enterprise may be obtained by summing up through channel C. The main gas meter refers to a gas meter that measures a total gas usage of the entire gas enterprise, the branch gas meter refers to a gas meter that measures a gas usage of a region, and the unit gas meter refers to a gas meter that measures a gas usage of a unit (a device). The gas usage of the gas enterprise refers to the total gas usage of the entire gas enterprise.

Further descriptions regarding the management platform, the gas user platform, the gas user object platform, and the gas equipment object platform may be found in FIG. 1 and related descriptions thereof.

In 220, estimated demand data of the gas enterprise is obtained based on the gas user platform.

The estimated demand data refers to data related to gas usage that is estimated by the gas enterprise. In some embodiments, the estimated demand data may include a plurality of future time periods and predicted demands corresponding to the plurality of future time periods.

The estimated demand refers to an amount of gas estimated to be demanded by the gas enterprise. For example, the estimated demand may be 400,000 cubic meters, 500,000 cubic meters, etc.

A future time period refers to a period of time in the future. In some embodiments, each future time period of the plurality of future time periods has the same length. The length and number of future time periods may be manually preset or set by default by the system. For example, the length of the future time period may be 1 week and the number may be 4, i.e., the plurality of future time periods may be every week within the next month (4 weeks).

In some embodiments, the estimated demand data may be represented by a sequence including a plurality of estimated demands of the future time periods. For example, estimated demand data of a manufacturing plant may be {50, 41, 47, 53, . . . }, indicating that estimated gas demand of the manufacturing plant of a future time period 1 is 500,000 cubic meters, and estimated gas demand of the manufacturing plant of a future time period 2 is 410,000 cubic meters, and so on.

In some embodiments, data amount of the gas monitoring data is greater than data amount of the estimated demand data. For example, the gas monitoring data may include gas usage for a plurality of historical time periods over a longer period of time in the past (e.g., 1 month), and the estimated demand data may include only estimated demand over a shorter period of time in the future (e.g., 1 week).

In some embodiments, the gas enterprise and/or the gas device may upload the estimated demand data, via the gas user object platform and/or the gas equipment object platform, to the IoT system for gas demand information management based on smart gas. The management platform may obtain the estimated demand data from the gas user object platform and/or the gas equipment object platform via the gas company sensing network platform.

In 230, a monitoring adjustment instruction and a data export instruction are generated based on the gas monitoring data and the estimated demand data, and the monitoring adjustment instruction and the data export instruction are sent to the gas user platform, the gas user object platform, and the gas equipment object platform.

The monitoring adjustment instruction refers to an instruction for adjusting parameters related to gas monitoring. In some embodiments, the monitoring adjustment instruction may include upload frequencies and upload priorities of gas monitoring data of the plurality of channels.

An upload frequency refers to a frequency of the platform uploading the gas monitoring data. For example, the upload frequency may be once every 12 hours.

An upload priority refers to a priority order for uploading the gas monitoring data. In some embodiments, the upload priority may be represented by an integer value. For example, the upload priority may be 1, 2, 3, 4, etc. The smaller the value, the higher the upload priority (i.e., smaller values are uploaded first).

In some embodiments, there is a monitoring adjustment instruction corresponding to each channel, i.e., there are corresponding upload frequency and upload priority. For example, the monitoring adjustment instruction may be expressed as “channel A (12 h/time, 1), channel B (10 h/time, 2), channel C (8 h/time, 3)”, which represents that an upload frequency of channel A is 12 h/time, and an upload priority of channel A is 1 (gas monitoring data of channel A is uploaded first), an upload frequency of channel B is 10 h/times, an upload priority of channel B is 2 (gas monitoring data of channel B is uploaded second), and an upload frequency of channel C is 8 h/times, an upload priority of channel C is 3 (gas monitoring data of channel C is uploaded last).

In some embodiments, the management platform may generate the monitoring adjustment instruction based on the gas monitoring data and the estimated demand data in a plurality of ways. For example, the management platform may determine reference gas data based on the gas monitoring data; determine an anomalous channel based on the gas monitoring data and the reference gas data; determine abnormal demand data based on the reference gas data and the estimated demand data; and generate the monitoring adjustment instruction based on the anomalous channel and the abnormal demand data.

The reference gas data refers to a reference amount of gas usage for determining whether the gas monitoring data is realistic. In some embodiments, a large difference between the gas monitoring data and the reference gas data represents a large deviation between the monitoring data and the actual data, i.e., an abnormality may have occurred in the channel corresponding to the gas monitoring data.

In some embodiments, the management platform may determine the reference gas data based on the gas monitoring data in a plurality of ways. For example, the closer the channel is to the upstream, the closer the monitoring results are to the actual value due to fewer uncertainties. The uncertainties may include less gas pipeline losses, meter errors, or the like. Thus, the management platform may designate the gas monitoring data corresponding to the most upstream channel as the reference gas data. The channel closer to the upstream refers to a channel that the gas flow passes through first, and the most upstream channel refers to a channel that the gas passes through first according to a gas flow direction.

The anomalous channel refers to a channel in which exists anomalous conditions. The abnormal conditions may include a gas pipeline failure, a gas monitoring device failure, etc.

In some embodiments, the management platform may determine the anomalous channel in a plurality of ways based on the reference gas data. For example, the management platform may calculate a similarity between the gas monitoring data corresponding to the plurality of channels and the reference demand data, denoted as a first similarity, and determine a channel corresponding to gas monitoring data with a first similarity that is less than a first similarity threshold as the anomalous channel.

The first similarity may be represented by a vector distance between the gas monitoring data and the reference demand data. The vector distance may be any one of a Euclidean distance, a cosine distance, a Mars distance, or the like. The first similarity threshold refers to a minimum threshold of similarity between the gas monitoring data and the reference demand data of a normal channel. The first similarity threshold may be determined manually based on a priori experience or historical data.

The abnormal demand data refers to estimated demand data that appears to be anomalous. The abnormal demand data characterizes anomalies in an estimated value of gas demand of a corresponding gas enterprise for its own gas demand in a future time period.

In some embodiments, the management platform may determine the abnormal demand data in a plurality of ways based on the reference gas data and the estimated demand data. For example, the management platform may process the reference gas data to have the same specifications as the estimated demand data, calculate a similarity between the reference gas data and the estimated demand data, denoted as a second similarity, and determine estimated demand data with a second similarity that is less than a second similarity threshold as the abnormal demand data. The plurality of future time periods of the estimated demand data may be every week within the next month, and the plurality of historical time periods of the reference gas data may be every day within the past month. The reference gas data of every week are respectively summed up to obtain the reference gas data with the same specification as the estimated demand data.

The second similarity may be represented by a vector distance between the reference gas data and the estimated demand data. The vector distance may be any one of a Euclidean distance, a cosine distance, a Mars distance, or the like. The second similarity threshold is the minimum threshold of similarity between the normal estimated demand data and the reference demand data. The second similarity threshold may be determined manually based on a priori experience or historical data.

In some embodiments, the management platform may generate the monitoring adjustment instruction based on the anomalous channel and the abnormal demand data in a plurality of ways. For example, the management platform may generate a monitoring adjustment instruction for reducing the upload frequency and reducing the upload priority for the anomalous channel based on a first predetermined relationship.

The first predetermined relationship may be determined manually based on a priori experience or historical data. For example, in order to avoid interference in the data analysis, the presence of the gas monitoring data from the anomalous channel needs to be reduced and the reception of the data from the normal channel is prioritized. Therefore, the first predetermined relationship may be that the smaller the first similarity, the smaller the upload frequency and the lower the upload priority of the monitoring adjustment instruction.

As another example, for a normal channel, the management platform may generate a monitoring adjustment instruction for increasing the upload frequency and increasing the upload priority for abnormal demand data based on the second predetermined relationship. The second predetermined relationship may be determined manually based on a priori experience or historical data. For example, for estimated demand data corresponding to the normal channel with a large difference from the reference gas data, the monitoring needs to be strengthened to provide more data support for the cause analysis. Therefore, the second predetermined relationship may be that the smaller the second similarity, the greater the upload frequency and the higher the upload priority of the monitoring adjustment instruction. If the estimated demand data of the normal channel is normal, i.e., the second similarity is not less than the second similarity threshold, the upload frequency and the upload priority remain unchanged.

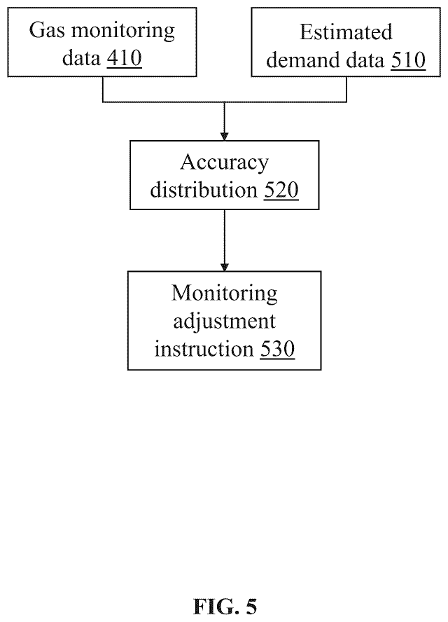

In some embodiments, the management platform may determine an accuracy distribution based on the gas monitoring data and the estimated demand data and generate the monitoring adjustment instruction based on the accuracy distribution. Further description regarding this section may be found in FIG. 5 and its related descriptions.

The data export instruction refers to an instruction that exports relevant data. In some embodiments, the data export instruction may include at least one channel and a flow log file and a gas monitoring device corresponding to the at least one channel.

The flow log file refers to a file in which gas-related data is logged by time. In some embodiments, the flow log file may include the gas usage and a gas flow rate for each unit of time for a predetermined time period. The gas flow rate refers to a rate at which the gas flows. For example, the gas flow rate may be 2 m/s, 5 m/s, or the like.

Both the predetermined time period and the unit of time may be preset manually. For example, the unit time may be every minute, every hour, etc. The predetermined time period may be the past week or the past month, etc. Compared to the gas monitoring data, the flow log file is more detailed and informative for cause analysis of the anomalous channel.

In some embodiments, each channel may correspond to one or more gas monitoring devices. For example, if channel B is the branch gas meter corresponding to each region of the gas enterprise, channel B corresponds to all branch gas meters in all regions.

In some embodiments, each gas monitoring device has a corresponding flow log file. When a channel is determined to be the anomalous channel, flow log files for all of the gas monitoring devices corresponding to the anomalous channel are exported.

For example, the data export instruction may be represented as “{B, 1[(5, 4, 2, . . . ), (3, 6, 4, . . . )], 2[(4, 3, 5, . . . ), (5, 3, 3, . . . )], . . . }”, which represents that for channel B is the anomalous channel, the anomalous channel B corresponds to a gas monitoring device 1 with an hourly gas usage of (5, 4, 2, . . . ) million cubic meters and a gas flow rate of (3, 6, 4, . . . ) meters per second in the past week, and a gas monitoring device 2 has a gas usage of (4, 3, 5, . . . ) million cubic meters per hour and a gas flow rate of (5, 3, 3, . . . ) meters per second for the past week, and so on.

In some embodiments, the management platform may generate the data export instruction based on the gas monitoring data and the estimated demand data in a plurality of ways. For example, the management platform may determine, based on the gas monitoring data, whether the channel is the anomalous channel, and in response to the channel being the anomalous channel, automatically generate the data export instruction based on the flow log file of the gas monitoring device corresponding to the anomalous channel.

In some embodiments, the management platform may determine, based on the gas monitoring data, whether the channel is the anomalous channel in various ways. For example, the management platform may compare the gas monitoring data of the channel with the reference gas data to determine whether the channel is the anomalous channel. More on this section may be found in the previous section on determining the anomalous channel based on reference gas data.

In some embodiments, in response to the channel being the anomalous channel, the management platform may generate the data export instruction in various ways. For example, the management platform may automatically generate the data export instruction based on the anomalous channel and an instruction template.

The instruction template refers to a template for data export instruction predefined manually or by the system. For example, the instruction template may be {X, S [M, N], . . . }, where X represents the anomalous channel, S represents the gas monitoring device, [M, N] represents the flow log file of the gas monitoring device, and M and N represent the gas usage and the gas flow rate in each unit of time for the predetermined time period, respectively.

In some embodiments, the management platform may send the data export instruction and the monitoring adjustment instruction to the gas user platform, the gas user object platform, and/or the gas equipment object platform based on the gas company sensing network platform.

In 240, based on the gas user object platform, the gas equipment object platform, and/or the gas user platform, the data export instruction is sent to the gas monitoring device corresponding to the at least one channel.

In some embodiments, in response to the generation of the data export instruction, the management platform may send the data export instruction, based on the gas user object platform, the gas equipment object platform, and/or the gas user platform, through the gas company sensing network platform to the gas monitoring device corresponding to the anomalous channel of each platform.

In 250, the gas monitoring device corresponding to the at least one channel is caused to export, based on the data export instruction, the flow log file outwardly from the log storage unit to the gas user object platform, the gas equipment object platform, and/or the gas user platform.

The log storage unit refers to a unit for storing the flow log file. For example, a memory of the gas monitoring device, etc. In some embodiments, the log storage unit may be provided in the gas monitoring device.

In some embodiments, the gas monitoring device receives the data export instruction, and may export its corresponding flow log file, via the gas company sensing network platform to the gas user object platform, the gas equipment object platform, and/or the gas user platform.

In some embodiments of the present disclosure, by using the gas monitoring data and the estimated demand data of the gas enterprise, it is determined whether an abnormal situation occurs in the channel, and the upload frequency and the upload priority of the gas monitoring data are dynamically adjusted according to the abnormal situation. Thus, the upload priority of the abnormal data may be reduced so as not to interfere with the data analysis, which may improve the accuracy of the estimated gas usage and protect the normal operation of the gas pipeline network.

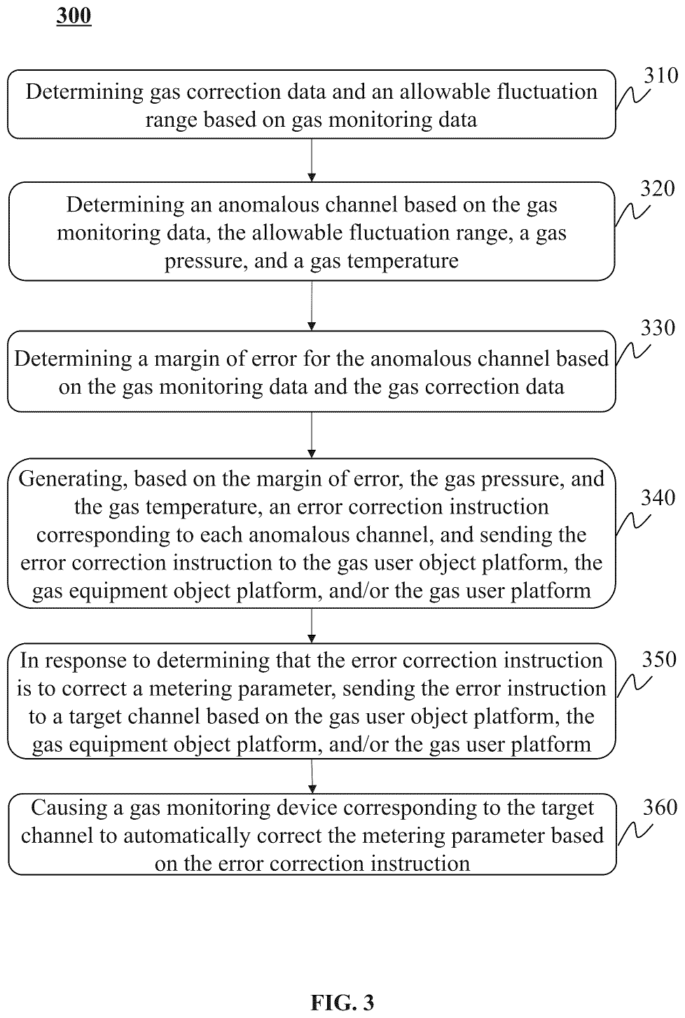

FIG. 3 is an exemplary flowchart illustrating an exemplary process of adjusting a metering parameter according to some embodiments of the present disclosure. As shown in FIG. 3, process 300 includes the following steps. In some embodiments, the process 300 may be realized (e.g., performed by a management platform) by the IoT system 100.

In 310, based on the gas monitoring data, the gas correction data and the allowable fluctuation range are determined.

Further descriptions regarding the gas monitoring data may be found in FIG. 2 and its related descriptions.

The gas correction data is gas monitoring data that has been corrected. In some embodiments, the gas correction data may be represented by a sequence including a plurality of pieces of average gas data for a plurality of historical time periods.

The average gas data refers to an average of gas usage for a historical time period. For example, if the average gas data for a historical time period 1 is 20000 cubic meters, this means that even if the gas usage is measured slightly differently by different channels, the gas usage for the historical time period 1 may be considered to be 20000 cubic meters.

In some embodiments, the management platform may determine the gas correction data based on the gas monitoring data in a plurality of ways. For example, the management platform may determine the gas correction data based on the gas monitoring data by a maximum likelihood estimation algorithm.

Because of unavoidable errors in the gas monitoring data obtained through monitoring, it is not possible to determine the average gas data by simple calculations solely on the gas monitoring data of each channel. Therefore, by default, all the channels obey the same normal distribution, the management platform may determine, through the maximum likelihood estimation algorithm, a mean value of the gas monitoring data of a plurality of channels for the same historical time period, and designate the mean value as the average gas data corresponding to the historical time period. Then, the management platform may determine a sequence composed of the average gas data corresponding to the plurality of historical time periods of all channels as the gas correction data.

The mean value (the average gas data) may be determined by the maximum likelihood estimation algorithm through the following equation (1):

$$μ = \frac{1}{n} {\sum }_{i = 1}^{n} {x}_{i} = \overline{x} \qquad ( 1 )$$

Where μ denotes the average gas data corresponding to the historical time period, xᵢ denotes the gas monitoring data corresponding to a channel i for the historical time period, and n denotes the number of channels. A historical time period corresponds to a mean value, i.e., corresponds to a piece of average gas data. A plurality of historical time periods correspond to a plurality of averages, i.e., correspond to a plurality of pieces of average gas data, and the sequence consisting of the plurality of pieces of average gas data of all channels is the gas correction data.

For example, all channels include channels A, B, C, D, and E. The gas monitoring data for channels A, B, C, D, and E are {a₁, a₂, a₃ . . . }, {b₁, b₂, b₃ . . . }, {c₁, c₂, c₃, . . . }, {d1₁, d₂, d₃, . . . }, {e1, e₂, e₃, . . . }, wherein {a1, a₂, a₃, . . . } denotes a gas usage of the channel A in a historical time period 1 is a1, a gas usage of the channel A in a historical time period 2 is a₂, a gas usage of the channel A in a historical time period 3 is a₃, and so on. Then the average gas data corresponding to the plurality of historical time periods for all channels (including a total of 5 channels, A, B, C, D, and E) are

$$\frac{( {a}_{1} + {b}_{1} + {c}_{1} + {d}_{1} + {e}_{1} )}{5} , \frac{( {a}_{2} + {b}_{2} + {c}_{2} + {d}_{2} + {e}_{2} )}{5} , \frac{( {a}_{3} + {b}_{3} + {c}_{3} + {d}_{3} + {e}_{3} )}{5} , … ,$$

which constitutes the sequence of the gas correction data

$$\{ \frac{( {a}_{1} + {b}_{1} + {c}_{1} + {d}_{1} + {e}_{1} )}{5} , \frac{( {a}_{2} + {b}_{2} + {c}_{2} + {d}_{2} + {e}_{2} )}{5} , \frac{( {a}_{3} + {b}_{3} + {c}_{3} + {d}_{3} + {e}_{3} )}{5} , … \} .$$

In some embodiments, the management platform may determine, based on the gas monitoring data, a grouping of the gas monitoring data of the plurality of channels through a first predictive model, and determine the gas correction data based on the grouping.

The first predictive model refers to a model configured to determine the grouping of the gas monitoring data of the plurality of channels. In some embodiments, the first predictive model may be a machine learning model, e.g., the first predictive model may be a Deep Neural Networks (DNN).

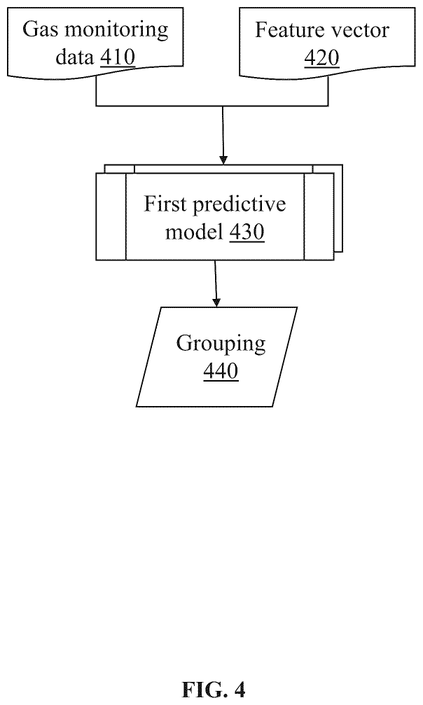

In some embodiments, as shown in FIG. 4, an input of the first predictive model 430 may include gas monitoring data 410 of the plurality of channels, and an output of the first predictive model 430 may be a grouping 440 of gas monitoring data of the plurality of channels.

The grouping of gas monitoring data of the plurality of channels refers to a grouping situation in which the channels corresponding to the gas monitoring data obeying the same normal distribution are divided into a group. A normal distribution corresponds to a grouping, and the same channel may be divided into one or more groups.

In some embodiments, the grouping may be represented by a sequence consisting of a plurality of channels corresponding to the same normal distribution. For example, a sub-group 1 may be denoted as {A, C, D}, representing that gas monitoring data of channels A, C, and D obey the same normal distribution, classified as the sub-group 1. As another example, a sub-group 2 may be denoted as {B, C, E}, representing that gas monitoring data of channels B, C, and E obey the same normal distribution, classified as the sub-group 2.

In some embodiments, the input of the first predictive model 430 may also include feature vectors 420 of the plurality of channels.

The feature vectors refer to vectors that characterize channels. In some embodiments, the feature vectors refer to vectors including a flow meter type, a flow meter accuracy, a flow meter measurement manner, a gas pressure, and a gas temperature corresponding to the channel.

The flow meter type refers to a type of flow meter. For example, the flow meter type may include a girdle flow meter, a turbine flow meter, and an ultrasonic flow meter, etc.

The flow meter accuracy refers to a degree to which the measured value of the flow meter deviates from the true value. In some embodiments, the flow meter accuracy may be an inherent property of the flow meter and be preset by a factory where the flow meter is produced. For example, the flow meter accuracy may be 0.5 level, 1 level, 1.5 level, etc., respectively, indicating that the maximum permissible error (the maximum value of the error between the measured value and the true value) is ±0.5%, ±1.0%, ±1.5%.

The flow measurement manner refers to a way or form in which the flow meter measures the gas flow. For example, the flow meter measurement manner may include a direct measurement, a summary measurement, or the like. The direct measurement refers to a measurement that uses results obtained from measurement by the flow meter as the gas flow rate. The summary measurement refers to a measurement that sums up and totalizes measurement results of a plurality of flow meters to determine the gas flow rate.

The gas pressure refers to a pressure of the environment in which the gas monitoring device is located. For example, the gas pressure may be 2 Kpa, 4 Kpa. In some embodiments, the gas pressure may be obtained by monitoring by a relevant device (e.g., a pressure sensor, etc.).

The gas temperature refers to the temperature of the environment in which the gas monitoring device is located. For example, the gas temperature may be 25° C., 30° C. In some embodiments, the gas temperature may be monitored and obtained by a relevant device (e.g., a temperature sensor, etc.).

In some embodiments, elements of the feature vectors may be represented by numeric values, i.e., the feature vectors may be represented as numeric vectors. For example, the feature vectors may be represented by 1, 2, and 3 for three flow meter types (e.g., for a girdle flow meter, a turbine flow meter, and an ultrasonic flow meter, respectively), and by 1 and 0 for different flow meter measurements (e.g., for the direct measurement and the summary measurement, respectively). That is, a feature vector a may be expressed as (1, 0.5, 1, 5, 20), which represents the flow meter type as the girdle flow meter, the accuracy of the flow meter as 0.5 level, the measurement of the flow meter as the direct measurement, the gas pressure as 2 Kpa, and the temperature of the gas as 20° C.

In some embodiments of the present disclosure, feature vectors representing the channel characteristics are also added to the input of the first predictive model, which takes into account the impact of different channels characteristics on the gas monitoring data, and improves the accuracy of the grouping.

In some embodiments, the management platform may train the first predictive model based on a plurality of first training samples with a first label. The first training samples may include sample gas monitoring data and sample feature vectors of a plurality of sample channels.

In some embodiments, the management platform may obtain the first training sample and the first label based on historical data. For example, the sample gas monitoring data may be historical gas monitoring data, and the sample feature vectors may be historical feature vectors. The management platform may randomly select a predetermined number (denoted as W) of sample channels from the plurality of historical channels, perform a normality test on gas monitoring data corresponding to the same historical time period of W sample channels. If a predetermined condition is met, the W sample channels are classified as a group and labeled as a first label.

Repeat multiple times to randomly draw W sample channels, repeat the process of judging the above, and obtain multiple first labels. The W may be the same as or different from a predetermined number previously drawn. Because too few samples are not suitable for normality test, there exists a minimum limit on the number of presets to ensure that the normality test is reasonable. The minimum limit of the predetermined number may be preset manually or systematically, e.g., W is greater than 10.

The predetermined condition refers to a condition that group channels into a set of corresponding gas monitoring data. The predetermined condition may be preset manually or by the system, e.g., the number of historical time periods in which the gas usage conforms to a normal distribution is greater than a predetermined threshold. The predetermined threshold may be preset manually or systematically, e.g., 20.

Exemplarily, 15 sample channels are randomly selected from the plurality of historical channels, the gas monitoring data of the 15 sample channels are obtained, the normality test is performed on gas monitoring data corresponding to the 15 sample channels. If the predetermined condition is met, it may be considered that the gas monitoring data corresponding to the 15 sample channels obey the same normal distribution, and the 15 sample channels are divided into a group and labeled as a first label. For example, the gas monitoring data of the above 15 sample channels is the gas usage for 30 historical time periods, and the predetermined condition is that the number of historical time periods in which the gas usage obeys a normal distribution is greater than 20. The gas usage of the 15 sample channels of each historical time period is tested for the normality test in turn. For example, the normality test is performed on the gas usage of the 15 sample channels of the historical time period 1 first, and then the normality test is performed on the gas usage of the 15 sample channels of the historical time period 2 until the normality test for 30 historical time periods is completed. That is to say, the gas usage of more than 20 historical time periods conforms to the normal distribution, then the predetermined condition may be considered to be met, i.e., the 15 sample channels may be classified into a group and labeled as a first label.

The normality test refers to a manner for determining whether a plurality of sets of data follow the normal distribution. In some embodiments, the normality test may be accomplished by an SPSS statistical analysis software, etc.

In some embodiments, the management platform may input the plurality of first training samples with the first label into an initial first predictive model, construct a first loss function from the first label and results of the initial first predictive model, and update a parameter of the initial first predictive model based on the first loss function by gradient descent algorithm or other iterative algorithm to update the parameter of the initial first predictive model. The model training is completed when a predetermined update condition is satisfied, and a trained first predictive model is obtained. Wherein the predetermined update condition may be that the first loss function is less than a first threshold, the first loss function converges, a count of iterations reaches a threshold, etc. or any combination thereof.

In some embodiments, the management platform may determine the gas correction data based on the gas monitoring data of the each sub-group in a plurality of ways. For example, the management platform may determine, by the maximum likelihood estimation algorithm, the average gas data corresponding to a plurality of historical time periods of each sub-group based on the gas monitoring data of each sub-group, constitute a sequence to determine the corresponding gas correction data of each sub-group, and determine an average value of sub gas correction data of each sub-group as the gas correction data.

For example, all channels are divided into two groups, group 1 is {A, C, D} and group 2 is {B, C, E}, and the gas monitoring data of channels A, B, C, D, and E are {a₁, a₂, a₃, . . . }, {b₁, b₂, b₃, . . . }, {c₁, c₂, c₃, . . . }, {d₁, d₂, d₃, . . . }, {e₁, e₂, e₃, . . . }, then the average gas data corresponding to the plurality of historical time periods of sub-group 1 are

$$\frac{( {a}_{1} + {c}_{1} + {d}_{1} )}{3} , \frac{( {a}_{2} + {c}_{2} + {d}_{2} )}{3} , \frac{( {a}_{3} + {c}_{3} + {d}_{3} )}{3} , … ,$$

which form sub gas correction data of group 1 to be

$$\{ \frac{( {a}_{1} + {c}_{1} + {d}_{1} )}{3} , \frac{( {a}_{2} + {c}_{2} + {d}_{2} )}{3} , \frac{( {a}_{3} + {c}_{3} + {d}_{3} )}{3} , … \} .$$

Similarly, sub gas correction data for group 2 is

$$\{ \frac{( {b}_{1} + {c}_{1} + {e}_{1} )}{3} , \frac{( {b}_{2} + {c}_{2} + {e}_{2} )}{3} , \frac{( {b}_{3} + {c}_{3} + {e}_{3} )}{3} , … \} .$$

Then the sub gas correction data of group 1 and group 2 are averaged to obtain the gas correction data as

$$\{ \frac{\frac{( {a}_{1} + {c}_{1} + {d}_{1} )}{3} + \frac{( {b}_{1} + {c}_{1} + {e}_{1} )}{3}}{2} , \frac{\frac{( {a}_{2} + {c}_{2} + {d}_{2} )}{3} + \frac{( {b}_{2} + {c}_{2} + {e}_{2} )}{3}}{2} , \frac{\frac{( {a}_{3} + {c}_{3} + {d}_{3} )}{3} + \frac{( {b}_{3} + {c}_{3} + {e}_{3} )}{3}}{2} , … \} .$$

In some embodiments of the present disclosure, with the aid of a machine learning model, the channels are grouped based on the gas monitoring data, and the gas monitoring data of the channels of the same grouping obeys the same normal distribution. Then, based on the grouping and gas monitoring data corresponding to the grouping, the gas correction data is determined, which not only improves the efficiency of determining the gas correction data, but also guarantees the accuracy of the data.

The allowable fluctuation range refers to a maximum error range that needs to be satisfied by an error between the gas monitoring data and the gas correction data when the gas monitoring data is normal. When the error between the gas monitoring data and the gas correction data exceeds the allowable fluctuation range, an abnormality needs to be determined for the channel corresponding to that gas monitoring data.

In some embodiments, the management platform may determine the allowable fluctuation range based on the gas monitoring data in a plurality of ways. For example, the management platform may determine a standard deviation of the gas monitoring data from the plurality of channels for the same historical time period by the maximum likelihood estimation algorithm, and determine the allowable fluctuation range corresponding to the historical time period based on the standard deviation.

The standard deviation may be determined by the maximum likelihood estimation algorithm through the following equation (2):

$${σ}^{2} = \frac{1}{n} {\sum }_{i = 1}^{n} {( {x}_{i} - μ )}^{2} \qquad ( 2 )$$

Where μ denotes average gas data corresponding to a certain historical time period (the mean of the normal distribution corresponding to a certain historical time period), xᵢ denotes the gas monitoring data corresponding to channel i for the historical time period, n denotes the number of channels, and σ denotes the standard deviation of the normal distribution corresponding to the gas monitoring data for the historical time period.

One historical time period corresponds to one standard deviation, i.e., corresponds to one allowable fluctuation range. A plurality of historical time periods correspond to a plurality of standard deviations, i.e., correspond to a plurality of allowable fluctuation ranges. In some embodiments, the management platform may use μ±2σ, μ±3σ, or μ±4σ as the allowable fluctuation range.

In 320, based on the gas monitoring data, the allowable fluctuation range, the gas pressure, and the gas temperature, the anomalous channel is determined.

Further descriptions regarding the anomalous channel may be found in FIG. 2 and its related descriptions.

In some embodiments, the management platform may determine the anomalous channel based on the gas monitoring data, the allowable fluctuation range, the gas pressure, and the gas temperature in a plurality of ways. For example, the management platform may determine a allowable fluctuation range for each historical time period of a channel based on the gas pressure and the gas temperature of the channel for each historical time period, determine an anomaly proportion based on the corresponding gas monitoring data and the allowable fluctuation range, and in response to the anomaly proportion being greater than a predetermined anomaly threshold, determine that the channel is the anomalous channel.

In some embodiments, the management platform may determine the allowable fluctuation range of each historical time period of the channel based on the gas pressure and the gas temperature of the channel by querying a first predetermined table.

The first predetermined table includes a first correspondence relationship between the gas pressure and the gas temperature and the allowable fluctuation range. The first correspondence relationship may be determined by a technician based on a priori experience or historical data. The first correspondence relationship may be that the higher the gas pressure, the higher the allowable fluctuation range; and the lower the gas temperature, the higher the allowable fluctuation range.

For example, for gas monitoring device that is set up at a place where the gas pressure is high and/or the gas temperature is low, the pressure has a greater influence on the measurement, the measurement results deviate more from the actual situation. Thus, it is more reasonable to set the allowable fluctuation range to be larger (e.g., μ±4σ). For the same channel, if allowable fluctuation ranges corresponding to the gas pressure and the gas temperature are different, the larger allowable fluctuation range shall prevail.

The anomaly proportion refers to a ratio of a historical time period in which gas monitoring data for a channel is abnormal to all historical time periods corresponding to that channel. For example, if gas monitoring data for a channel is gas usage for 30 historical time periods, and 10 of those historical time periods are abnormal, the anomaly proportion is ⅓, or about 33%.

In some embodiments, for each historical time period, the management platform may compare the corresponding allowable fluctuation range with the corresponding gas monitoring data. If the gas monitoring data exceeds the allowable fluctuation range, it is determined that an abnormality occurs in the historical time period

The predetermined anomaly threshold refers to a maximum value of an anomaly proportion in a normal channel. The predetermined anomaly threshold may be determined by a technician based on a priori experience or historical data, or set by the system by default.

In some embodiments, in response to the anomaly proportion being greater than a predetermined anomaly threshold, the channel may be determined as the anomalous channel. For example, if the predetermined anomaly threshold is 30%, and the anomaly proportion 33% is greater than the predetermined anomaly threshold 30%, the channel may be determined to be the anomalous channel.

In 330, a margin of error for the anomalous channel is determined based on the gas monitoring data and the gas correction data.

The margin of error refers to a difference between the gas monitoring data and the gas correction data of the anomalous channel. In some embodiments, the management platform may determine the margin of error based on the gas monitoring data and the gas correction data in a plurality of ways.

For example, the margin of error may be represented by a vector distance between a sequence of the gas monitoring data and a sequence of the gas correction data. The vector distance between the gas monitoring data and the gas correction data, i.e., the margin of error, may be determined by the following equation (3):

$$γ = \frac{{\sum }_{j = 1}^{m} {x}_{j} {y}_{j}}{\sqrt{{\sum }_{j = 1}^{m} {x}_{j}^{2}} \sqrt{{\sum }_{j = 1}^{m} {y}_{j}^{2}}} \qquad ( 3 )$$

Wherein γ denotes the margin of error, m denotes a count of historical time periods corresponding to the gas monitoring data, xⱼ denotes the gas monitoring data (the gas usage in the historical time period j), and yⱼ denotes the gas correction data (the average gas data in the historical time period j).

In 340, based on the margin of error, the gas pressure, and the gas temperature, an error correction instruction corresponding to each anomalous channel is generated and sent to the gas user object platform, the gas equipment object platform, and/or the gas user platform, respectively.

The error correction instruction refers to a control instruction that corrects an error. In some embodiments, the error correction instruction may include at least correcting a metering parameter, removing pipeline impurities, removing equipment impurities, replacing a meter, pipeline leakage detection, or the like.

The metering parameter refers to a setting parameter of the gas monitoring device. The metering parameter may include a monitoring frequency, a metering accuracy, etc. The monitoring frequency refers to a frequency of gas flow measured by the gas monitoring device per unit time. For example, a monitoring frequency of 2 times/minute means that the gas monitoring device measures the gas flow rate 2 times per minute.

The measurement accuracy refers to an accuracy of a measurement made by the gas monitoring device. The measurement accuracy may be represented in terms of levels, for example, the measurement accuracy may be 0.5 level, 1 level, 1.5 level, etc., which indicates a maximum allowable error of ±0.5%, ±1.0%, and ±1.5%, respectively. The maximum allowable error refers to the maximum value of the error between the measured value and the true value.

Correcting the metering parameter means adjusting the metering parameter. For example, correcting the metering parameter may include increasing the monitoring frequency and/or increasing the metering accuracy, etc.

The pipeline impurities refer to impurities in the gas pipeline. The equipment impurities refer to impurities in the gas monitoring device. For example, the impurities may include dust, garbage, or particulate residue left behind by a gas that is not pure enough, etc.

In some embodiments, the metering parameter may be corrected by the gas monitoring device, or may be corrected manually by a technician.

In some embodiments, operations of removing pipeline impurities, removing equipment impurities, replacing meters, pipeline leakage detection, or the like, may be performed by maintenance personnel dispatched from various gas user service platforms according to the error correction instruction.

Since a too large margin of error of the anomalous channel may cause a large impact on the subsequent monitoring, it is necessary to determine the cause of the error through the margin of error timely and determine a corresponding error correction instruction.

In some embodiments, the management platform may generate the error correction instruction by querying a second predetermined table based on the margin of error, the gas pressure, and the gas temperature. The second predetermined table includes a second correspondence relationship of the margin of error, the gas pressure, and the gas temperature to the error correction instruction. The second correspondence relationship may be determined by a technician based on a priori experience or historical data.

Exemplarily, the second correspondence relationship may be that the greater the margin of error, the greater the pressure of the metering environment, and the greater the temperature of the metering environment, the greater the number of ways in which the error may be corrected, and the greater the strength of the error correction. Exemplarily, for a channel corresponding to gas monitoring data with a larger margin of error, not only the metering parameter of the gas monitoring device is required to be corrected, but also the pipeline impurities and the equipment impurities are required to be removed.

In some embodiments, the management platform may send the error correction instruction to the gas user object platform, the gas equipment object platform, and/or the gas user platform via the gas company sensing network platform. Detailed descriptions regarding the gas company sensing network platform may be found in FIG. 1 and its related descriptions.

In 350, in response to determining that the error correction instruction is to correct the metering parameter, the error correction instruction is sent to a target channel based on the gas user object platform, the gas equipment object platform, and/or the gas user platform.

The target channel refers to a channel for which error correction is required. In some embodiments, the target channel may be a channel corresponding to the error correction instruction.

In some embodiments, in response to determining that the error correction instruction is to correct the metering parameter, the management platform may send the error correction instruction to a corresponding target channel based on the gas user object platform, the gas equipment object platform, and/or the gas user platform.

In 360, the gas monitoring device corresponding to the target channel is caused to automatically adjust the metering parameter based on the error correction instruction.

In some embodiments, each target channel may correspond to one or more gas monitoring devices.

In some embodiments, the target channel receives the error correction instruction, and the gas monitoring device corresponding to the target channel may adjust the metering parameter on its own in response to the error correction instruction. For example, in response to the target channel receiving an error correction instruction to adjust the metering accuracy to 0.5 level, all gas monitoring devices corresponding to the target channel may adjust the metering accuracy to 0.5 level on their own.

In some embodiments of the present disclosure, by determining the gas correction data and the allowable fluctuation range through the gas monitoring data and further combining with the gas pressure and the gas temperature, the difference between the gas monitoring data and the gas correction data corresponding to the channel may be determined. It may determine whether an abnormal situation occurs in the channel, and the error correction instruction is issued timely for the abnormal situation and the margin of error, which may quickly and efficiently deal with the gas monitoring faults, ensure the accuracy of the gas monitoring data, thus improving the accuracy of the gas demand prediction.

It should be noted that the foregoing descriptions of the processes 200 and 300 are for the purpose of example and illustration only and do not limit the scope of application of the present disclosure. For those skilled in the art, various corrections and changes may be made to processes 200 and 300 under the guidance of the present disclosure. However, these corrections and changes remain within the scope of the present disclosure.

FIG. 5 is an exemplary schematic diagram illustrating generating a monitoring adjustment instruction according to some embodiments of the present disclosure.

In some embodiments, as shown in FIG. 5, the management platform may determine an accuracy distribution 520 based on the gas monitoring data 410 and estimated demand data 510 and generate a monitoring adjustment instruction 530 based on the accuracy distribution 520.

Further descriptions regarding the gas monitoring data, the estimated demand data, and the monitoring adjustment instruction may be found in FIG. 2 and its related descriptions.

An accuracy refers to a degree to which the estimated demand data matches actual demand data. The actual demand data refers to a gas usage that is actually required by the gas enterprise. In some embodiments, the accuracy may be represented by a numerical value. The closer the accuracy is to 1, the closer the estimated demand data is to the actual demand data.

The accuracy distribution refers to a sequence of accuracies for a plurality of future time periods. For example, the accuracy distribution may be {0.7, 0.6, 0.8, . . . }, representing that an accuracy of a future time period 1 of 0.7, an accuracy of a future time period 2 is 0.6, an accuracy of a future time period 3 is 0.8, and so on.

In some embodiments, the management platform may determine the accuracy distribution based on the gas monitoring data and the estimated demand data in a plurality of ways. For example, the management platform may determine gas correction data based on the gas monitoring data and determine the accuracy distribution based on the gas correction data and the estimated demand data.

Further descriptions regarding the gas correction data and the estimated demand data may be found in FIG. 3 and FIG. 2 and their related descriptions.

In some embodiments, the management platform may determine the accuracy distribution based on the gas correction data and the estimated demand data in a plurality of ways. For example, the accuracy distribution may be determined by the following equation (4):

$$α = \frac{1}{2} * \{ \begin{matrix}\frac{{m}_{1}}{{n}_{1}} + \frac{\frac{{m}_{1}}{{m}_{4}}}{\frac{{n}_{1}}{{n}_{1}}} , & \frac{{m}_{2}}{{n}_{2}} + \frac{\frac{{m}_{2}}{{m}_{1}}}{\frac{{n}_{2}}{{n}_{1}}} , & \frac{{m}_{3}}{{n}_{3}} + \frac{\frac{{m}_{3}}{{m}_{2}}}{\frac{{n}_{3}}{{n}_{2}}} , & \frac{{m}_{4}}{{n}_{4}} + \frac{\frac{{m}_{4}}{{m}_{3}}}{\frac{{n}_{4}}{{n}_{3}}} , & …\end{matrix} \} \qquad ( 4 )$$

Wherein α denotes the accuracy distribution, (m₁, m₂, m₃, and m₄ . . . ) denotes the estimated demand data, m₁, m₂, m₃, and m₄ denote the estimated demand for future time periods 1, 2, 3, and 4, respectively, (n₁, n₂, n₃, n₄ . . . ) denotes the gas correction data, n₁, n₂, n₃, and n₄ denote the historical average gas data for historical time periods 1, 2, 3, and 4. The historical time period refers to a processed historical time period of the same length as the future time period. For example, the future time period is a weekly period of a future month, and the historical time period is originally a daily period of the past month, which is summed and processed, and the historical time period is a sum of seven days corresponding to a weekly period of the past month.

Taking the future time period 2 as an example, its corresponding estimated demand is m₂ and the average gas data is n₂.

$$\frac{{m}_{2}}{{n}_{2}}$$

may represent a gap between the estimated demand and the average gas data; m2 m1 is the rate of change of the estimated demand of the future time period 2 relative to the future time period 1.

$$\frac{{m}_{2}}{{m}_{1}}$$

may represent a change rate of the estimated demand in future time period 2 relative to the estimated demand in future time period 1.

$$\frac{{n}_{2}}{{n}_{1}}$$

may represent a change rate of the average gas data in future time period 2 relative to the average gas data in future time period 1.

In some embodiments, the management platform may determine gas future data based on the gas correction data and determine the accuracy distribution based on the estimated demand data and the gas future data.

Further descriptions regarding the gas correction data may be found in FIG. 3 and its related descriptions.

The gas future data refers to data related to gas usage for a predicted future time period.

In some embodiments, the gas future data may be represented by a sequence including gas usage of a plurality of future time periods. For example, the gas future data of a manufacturing plant may be {43, 46, 51, . . . }, indicating that the estimated gas usage of the manufacturing plant in the future time period 1 is 43 million cubic meters, the estimated gas usage of the manufacturing plant in the future time period 2 is 460,000 cubic meters, and so on.

Further descriptions regarding the future time period may be found in FIG. 2 and its related descriptions.

In some embodiments, the management platform may determine gas future data based on the gas correction data, in a plurality of ways. For example, the management platform may determine, based on the gas correction data of the plurality of historical time periods, a functional relationship between the gas usage and the time by modeling a regression to determine the gas usage of the future time period based on the functional relationship. In turn, the gas future data is obtained. The modeling regression may include, but is not limited to, a logistic regression model, a random forest model, or an SVM model, etc.

In some embodiments, the management platform may determine first future data based on the gas correction data via a second predictive model.

The first future data refers to the estimated demand data of the gas enterprise predicted according to data of the gas enterprise. In some embodiments, the first future data may be represented by a sequence including a plurality of estimated demands of the plurality of future time periods. For example, if the first future data is (59, 43, 54, . . . ), an estimated demand predicted in the future time period 1 is 590,000 cubic meters, an estimated demand predicted in the future time period 2 is 430,000 cubic meters, an estimated demand predicted in the future time period 3 is 540,000 cubic meters, and so on.

The second predictive model refers to a model for determining the first future data. In some embodiments, the second predictive model may be a machine learning model, e.g., the second predictive model may be a Neural Network (NN), a Deep Neural Network (DNN), or the like.

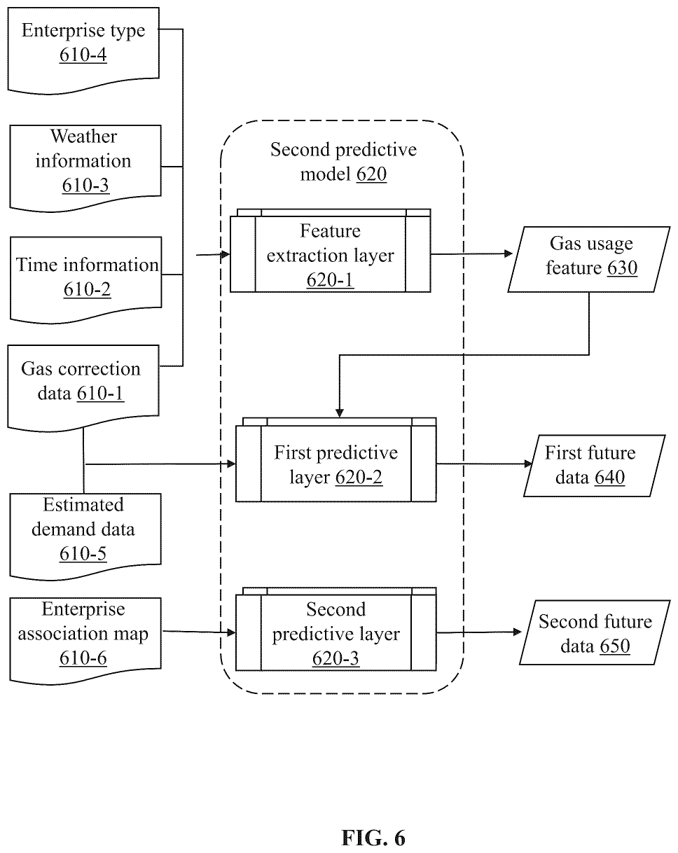

In some embodiments, a second predictive model 620 includes a feature extraction layer 620-1 and a first predictive layer 620-2, as shown in FIG. 6.

The feature extraction layer 620-1 refers to a model for determining a gas usage feature. In some embodiments, the feature extraction layer may be a machine learning model. For example, the feature extraction layer may be a Convolutional Neural Network (CNN), etc.

In some embodiments, as shown in FIG. 6, an input of the feature extraction layer 620-1 may include gas correction data 610-1, time information 610-2, weather information 610-3, and enterprise type 610-4, and an output of the feature extraction layer 620-1 may be the gas usage feature 630 of the gas enterprise.

The time information refers to information related to the historical time period. The time information may include holiday information, seasonal information, or month information. In some embodiments, the management platform may determine the time information via a perpetual calendar, etc.

In some embodiments, the time information may be represented by a vector including the holiday information and the seasonal information, or the holiday information and the month information. For example, the management platform may use different symbols to distinguish whether a time period is on a holiday, and use English and numbers to represent the seasonal information and the month information, respectively.

Exemplarily, + represents being on a holiday, − represents not being on a holiday, and \textcircled{1}˜\textcircled{1}2 represent months. If the time information is (+\textcircled{1}, −\textcircled{2}, −\textcircled{6}, +\textcircled{9}), it indicates that history time period 1 is a holiday in January history time period 2 is a non-holiday in February; history time period 3 is a non-holiday in June; and history time period 4 is a holiday in September.

The historical time period may include multiple days, and the management platform may determine whether the historical time period may be designated as a holiday based on a ratio of the number of holidays to the total number of days in the historical time period within the historical time period. For example, if the ratio is more than 50%, the historical time period may be a holiday.

The weather information refers to information related to the weather in the historical time period. The weather information may include sunny, cloudy, rainy, snowy, etc. In some embodiments, the management platform may obtain the weather information through a third-party platform, such as a weather forecasting website.

In some embodiments, the weather information may be represented by vectors including sunny, cloudy, rainy, and snowy. For example, the weather information (snow, rain, sunny) may indicate that history time period 1 is snowy, history time period 2 is rainy, and history time period 3 is sunny.

In some embodiments, the historical time period corresponding to the weather information and the time information may be the same as the historical time period corresponding to the gas monitoring data.

The enterprise type refers to a type of gas enterprise. The enterprise type may include automotive factories, electronics factories, food factories, or the like. In some embodiments, the enterprise type may also include a type of product of the gas enterprise. For example, the enterprise type could include the electronics factories and the type of electronic products they product (e.g., cell phones, tablets, or electronic parts, etc.).

In some embodiments, the enterprise type affects the peaks and lows of gas consumption of a gas enterprise. For example, if the enterprise type is a food factory, gas consumption peaks may occur more frequently. In some embodiments, the enterprise type may be determined based on enterprise registration information.

The gas usage feature refers to a parameter used to reflect gas usage habits of the gas enterprise. In some embodiments, the gas usage feature may include cycle information of gas usage by the gas enterprise, a gas usage fluctuation, or the like. The cycle information may include information related to peaks and lows of gas consumption, etc. For example, the cycle information may include peak periods of gas consumption, etc. The gas usage fluctuation refers to a change in gas usage. The gas usage fluctuation may be a situation where gas usage is more uniformly regular, or where there is a sudden rise or fall in gas usage, etc., and a change amount of gas usage.

The first predictive layer 620-2 refers to a model for determining the first future data. In some embodiments, the first predictive layer may be a machine learning model. For example, the first predictive layer may be a Convolutional Neural Network (CNN), etc.

In some embodiments, as shown in FIG. 6, an input of the first predictive layer 620-2 may include the gas correction data 610-1, the estimated demand data 610-5, and the gas usage feature 630, an output of the first predictive layer 620-2 may include the first future data 640.

In some embodiments, the second predictive model 620 further includes a second predictive layer 620-3, as shown in FIG. 6.

The second predictive layer 620-3 refers to a model for determining second future data. In some embodiments, the second predictive layer may be a machine learning model. For example, the second predictive layer could be a Graph Neural Network (GNN).

The second future data refers to the estimated demand data of the gas enterprise that is predicted in combination with data from other gas enterprise associated with the gas enterprise. In some embodiments, the second future data may be represented by a sequence including a plurality of predicted demands of the plurality of future time periods. For example, for the second future data (59, 43, 54, . . . ), an estimated demand predicted in future time period 1 is 590,000 cubic meters, an estimated demand predicted in future time period 2 is 430,000 cubic meters, and an estimated demand predicted in future time period 3 is 540,000 cubic meters.

In some embodiments, an input of the second predictive layer 620-3 may include an enterprise association map 610-6, and an output of the second predictive layer 620-3 may include second future data 650, as shown in FIG. 6.

The enterprise association map 610-6 refers to a diagram for representing an association relationship between enterprises. In some embodiments, the enterprise association map may include a plurality of nodes and a plurality of edges.

In some embodiments, the nodes of the enterprise association map may include a gas enterprise, and node features may be first future data of the gas enterprise.

In some embodiments, the edges of the enterprise association map may include an upstream and downstream enterprise edge and a similar enterprise edge, and edge features may be gas association values.

The upstream and downstream enterprise edge is a directed edge connecting gas enterprises that have upstream and downstream relationships. A direction of the directed edge is that an upstream enterprise pointing to a downstream enterprise. Where the upstream and downstream relationships refer to that two gas enterprises are in the upstream and downstream of the same industrial chain.

For example, for an automobile trolley manufacturer, its downstream enterprises may include an automobile distribution company and an automobile sales company, and its upstream enterprises may include an automobile battery manufacturer and an automobile tire manufacturer, etc. There are four upstream and downstream enterprise edges in which the automobile trolley manufacturer points to the automobile distribution company and the automobile sales company, and the automobile battery manufacturer and the automobile tire manufacturer point to the automobile trolley manufacturer.

The similar enterprise edge refers to an undirected edge connecting gas enterprises that belong to the same enterprise type. The enterprises that belong to the same enterprise type refer to gas enterprises that have the same enterprise type or the same position in the same industry chain.

For example, gas enterprise P1 and gas enterprise P2, which are the same as the automobile tire manufacturer, are the same type of enterprise, and the similar enterprise edge connects the two. Alternatively, if the gas enterprise P1 is the automobile tire manufacturer and the gas enterprise P2 is the automobile battery manufacturer, both of which belong to the upstream enterprise in the industry chain, there is no obvious upstream and downstream relationship between the two, and the gas enterprise P1 and the gas enterprise P2 are located in the same position in the same industry chain, then the gas enterprise P1 and the gas enterprise P2 are same type of enterprise and the similar enterprise edge connects the two.

The gas association value refers to a value that characterizes a correlation relationship between gas correction data of two gas enterprise in different historical time periods. In some embodiments, the gas association value may be determined based on a similarity of change trend vectors of gas correction data of two gas enterprises. For example, the management platform may determine a change trend vector of the gas correction data based on average gas data in the plurality of historical time periods and determine the gas association value based on the change trend vector.

The change trend vector refers to a vector consisting of change trends of average gas data of a historical time period compared to a previous historical time period. Exemplarily, the change trend vector is (10%, 6%, −5%, 3%), indicating a 10% increase in average gas data of historical time period 1 compared to the previous historical time period; and a 6% increase in average gas data of historical time period 2 compared to historical time period 1, and so on.

The management platform may calculate a similarity of two gas enterprises based on a change trend vector of gas correction data of the same historical time period corresponding to the two gas enterprises, which is recorded as a third similarity. The management platform may determine the third similarity as the gas association value of the two gas enterprises connected by the edge. The third similarity may be represented by a vector distance of the change trend vector. The vector distance may be any of a Euclidean distance, a cosine distance, a Mars distance, or the like.

In some embodiments of the present disclosure, through the second predictive layer of the second predictive model, the enterprise association map is introduced as the input of the model, which takes into account the effect of the association relationship between gas enterprises on the gas usage and improves accuracy and rationality of output results of the model.

In some embodiments, the management platform may jointly train the feature extraction layer and the first predictive layer based on a plurality of second training samples with a second label. The second training samples may include sample gas correction data, sample time information, sample weather information, sample enterprise type, and sample estimated demand data of a first historical time period. The second training samples and the second label may be determined based on the historical data. The second label may be actual first future data corresponding to the second historical time period, i.e., actual gas monitoring data corresponding to the second historical time period, and the second label may be manually labeled. The first historical time period precedes the second historical time period.

In some embodiments, the feature extraction layer and the first predictive layer may be obtained by jointly training the plurality of second training samples with the second label. The management platform may input the sample gas correction data, the sample time information, the sample weather information, and the sample enterprise type from the second training samples into the feature extraction layer to output the gas usage feature, and output the first future data by inputting the gas usage feature output by the feature extraction layer, and the sample gas correction data and the sample estimated demand data in the second training samples into the first predictive layer. A second loss function is constructed from the first future data and the second label output from the first predictive layer, and parameters of the feature extraction layer and the first predictive layer are updated based on the second loss function by gradient descent algorithm or other iterative algorithms. The model training is completed when a predetermined update condition is satisfied, and a trained feature extraction layer and a trained first predictive layer are obtained. The preset predetermined condition may be that the second loss function is less than a second threshold, the second loss function converges, a count of iterations reaches a threshold, etc. or any combination thereof.

In some embodiments, the management platform may individually train the second predictive layer with a plurality of third training samples with a third label. The third training samples include sample enterprise association map of the first historical time period. The third label and the third training samples may be obtained based on the historical data. The third label may be actual second future data corresponding to the second historical time period (actual gas monitoring data corresponding to the second historical time period), and the third label may be manually labeled.

In some embodiments, the second predictive layer may be obtained by training the plurality of third training samples with the third label. The training process is the same as that for the first predictive model and is not described herein. The trained feature extraction layer, the first predictive layer, and the second predictive layer are obtained through training, then a trained second predictive model is obtained.

In some embodiments, the training process of the second predictive model may include determining different training sample sets and corresponding labels based on the enterprise type and alternating the training of the different training sample sets according to the size.

The training sample sets refer to sets of training samples used for alternate training. The labels corresponding to the training sample sets refers to labels of the training samples in the training sample sets, which is denoted as fourth labels. In some embodiments, the training sample set may include a plurality of fourth training samples with fourth labels. The fourth training samples may include a second training sample and a third training sample.

In some embodiments, the management platform may determine different sets of training samples and labels corresponding to the different sets of training samples according to the historical data based on the enterprise type. The historical data may include historical gas correction data, historical time information, historical weather information, a historical enterprise type, historical estimated demand data, and a historical enterprise association map.

The management platform may build a collection of historical data of enterprises of the same type based on the enterprise type, which is determined as a training sample set. That is, the second training sample and the third training sample corresponding to an enterprise of the same type are determined as a set of fourth training samples. The second training sample and the third training sample corresponding to a plurality of enterprises of the same type are determined as a plurality of sets of fourth training samples, constituting a plurality of training sample sets, and labels corresponding to the fourth training samples are the fourth labels. The fourth labels may include a third label, i.e., actual second future data corresponding to the sample enterprise association map of the first historical time period in the second historical time period.

In some embodiments, the size of the training sample set may be indicated by data amount in the training sample set (a count of fourth training samples). The larger the count of fourth training samples, the larger the size of the training sample set.

In some embodiments, the management platform may alternate training of different training sample sets according to the size. Alternating training means alternating training with training sample sets of different sizes. For example, R₁, R₂, R₃, and R₄ are training sample sets of increasing size, R₁ and R₂ are considered as training sample sets of smaller size, and R₃ and R4 are considered as training sample sets of larger size, thus, R₁, R₃, R₂, and R4 (or R₁, R₄, R₂, R₃; R₂, R₄, R₁, R₃; R₂, R₃, R₁, R₄; R₂, R₃, R₁, R₄, etc.) may be used in sequence to train the second predictive model. The same training sample set may be used repeatedly for alternate training.

A learning rate refers to a parameter that characterizes a step size of the iterative updating of model parameters during model training. The higher the learning rate, the larger the step size of updating the model parameter. In some embodiments, the fourth training samples in different training sample sets have different learning rates during training.

In some embodiments, the learning rate may be adjusted based on a training sample feature.

The training sample feature refers to a feature of the training sample. In some embodiments, the training sample feature may include a source and a reliability of the fourth training samples. The source of the fourth training samples refers to the enterprise type corresponding to the fourth training samples.

The reliability of the fourth training samples refers to a degree of consistency of the fourth labels corresponding to the fourth training samples in the training sample set. For example, for a plurality of fourth training samples in the same training sample set, a plurality of fourth labels corresponding to the plurality of fourth training samples are consistent or mostly consistent (e.g., the degree of consistency is greater than 80%), the training effect is better, and the reliability of the fourth training samples is higher. If the plurality of fourth labels are inconsistent (e.g., the degree of consistency is less than 50%), and the actual gas usage corresponding to the future time period of the same fourth training samples are different, then the training effect is poor and the reliability of the fourth training samples is low.

The degree of consistency may be represented by a percentage of consistent fourth labels among the plurality of fourth labels corresponding to the plurality of fourth training samples in the training sample set. For example, if 40 fourth labels among 50 fourth labels are consistent, the degree of consistency is 80%.

In some embodiments, the management platform may determine the learning rates of the fourth training samples of different training sample sets by querying a vector database based on the training sample feature. The vector database includes at least a reference training sample feature and a reference learning rate. The management platform may construct a plurality of reference training sample features based on a source of a historical fourth training sample and a reliability of the historical fourth training sample. The historical learning rate corresponding to the reference training sample feature is the reference learning rate. A vector distance between the training sample feature and each of the plurality of reference training sample features is calculated, a reference learning rate corresponding to a reference training sample feature with the smallest vector distance is designated as a current learning rate. The vector distance may include a Euclidean distance, a cosine distance, or the like.

In some embodiments of the present disclosure, dividing the training samples into different training sample set and alternating training according to the size of the training sample set may reduce the data amount of each training and improve the efficiency of the model training.

In some embodiments of the present disclosure, by using the trained second predictive model, the gas usage of the gas enterprise in the future time period may be predicted accurately and reasonably, facilitating the overall coordination and management of the gas network, and improving efficiency of the operation of the gas pipeline network.

In some embodiments, the management platform may determine the accuracy distribution based on the estimated gas demand data and the gas future data in a plurality of ways. For example, the management platform may calculate the accuracy based on the estimated demand data and the gas future data through the following equation (5), which in turn determines a sequence consisting of accuracies corresponding to a plurality of future time periods as the accuracy distribution.

$$β = \frac{{G}_{p}}{{G}_{f}} \qquad ( 5 )$$

Wherein β denotes the accuracy, Gₚ denotes the estimated demand data, and G_{f} denotes the gas future data. The closer the β is to 1, the higher the reliability of the estimated demand data.

In some embodiments of the present disclosure, determining the gas future data from historical data, comparing predicted gas future data with estimated demand data provided by the enterprise, and determining the accuracy, may improve the accuracy and completeness of the determination.

More descriptions regarding the monitoring adjustment instruction may be found in FIG. 2 and its related descriptions.

In some embodiments, the management platform may determine adjustment amounts of upload frequencies of the first future time period and the second future time period by querying a third predetermined table based on the accuracy corresponding to a certain future time period (noted as the first future time period).

The second future time period precedes the first future time period. The second future time period may be a time period at the end of a future time period preceding the first future time period. Meanwhile, the remaining time period in a future time period preceding the first future time period other than the second future time period is noted as a third future time period, i.e., the third future time period precedes the second future time period. The third future time period and the second future time period constitute a future time period preceding the first future time period.

For example, if a certain future time period is future time period 2, noted as the first future time period, a second future time period may be a time period at the end of the historical time period 1, and the third future time period may be a time period in the historical time period 1 other than the remaining period of the second future time period That is, ([third future time period, second future time period]=historical time period 1, first future time period=future time period 2).

The third predetermined table includes a third correspondence relationship between the accuracy and the adjustment amount of the upload frequency. The third correspondence relationship may be determined by a technician based on a priori experience or historical data. For example, the third correspondence relationship may be a negative correlation between the accuracy and the adjustment amount of the upload frequency (e.g., the higher the accuracy, the smaller the adjustment amount of the upload frequency, etc.).

In some embodiments, the management platform may automatically generate the monitoring adjustment instruction based on the adjustment amount of the upload frequency, according to an instruction template. The instruction template may be set by a technician or by system default. Each future time period has a corresponding accuracy, i.e., there is a corresponding adjustment amount of the upload frequency.

For example, accuracies of future time periods 4, 5, and 6 are 0.7, 0.1, and 0.7, respectively. According to the third predetermined table, it is determined that an adjustment amount of an upload frequency corresponding to future time period 6 is 0h/times, an adjustment amount of an upload frequency corresponding to a second future time period of future time period 4 is −1.5 h/times, and an adjustment amount of an upload frequency corresponding to a third future time period of the future time period 4 is 0h/times, and an adjustment amount of an upload frequency corresponding to future time period 5 is −2 h/time. Then, the monitoring adjustment instruction may be expressed as “future time period 4 (0 h/time, −1.5 h/time), future time period 5 (−2 h/time), future time period 6 (0 h/time)”, representing that the upload frequency of the third future time period of the future time period 4 is unchanged, and the upload frequency of the second future time period of the future time period 4 is improved by 1.5 h/time (e.g., from 12 h/time to 10.5 h/time), the upload frequency of the future time period 5 is increased by 2 h/time, and the upload frequency of future time period 6 remains unchanged.

In some embodiments, the management platform may adjust the upload frequency in a second future time period of a previous future time period of a certain future time period that requires the upload frequency to be adjusted, and within the certain future time period. For example, if the future time period is measured in months and the accuracy of a future time period (e.g., October) is low, the upload frequency is adjusted within the second future time period (e.g., the last 5 days of September) of the previous future time period of the future time period and within the future time period (October).

In some embodiments of the present disclosure, by determining the accuracy distribution, and then determining the monitoring adjustment instruction, the degree of consistency between the estimated demand data and the actual demand data may be determined. For data with a lower degree of consistency, the gas monitoring data is adjusted timely, which ensures the accuracy and timeliness of the predicted gas usage data, and guarantees the normal operation of the gas pipeline network.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and amendments are intended to be suggested by this disclosure and are within the spirit and scope of the exemplary embodiments of the present disclosure.

Moreover, certain terminology has been used to describe embodiments of the present disclosure. For example, the terms one embodiment, “an embodiment,” and/or “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. In addition, some features, structures, or characteristics of one or more embodiments in the present disclosure may be properly combined.

Furthermore, the recited order of processing elements or sequences, or the use of numbers, letters, or other designations, therefore, is not intended to limit the claimed processes and methods to any order except as may be specified in the claims. Although the above disclosure discusses some embodiments of the invention currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the present disclosure. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes. History application documents that are inconsistent or conflictive with the contents of the present disclosure are excluded, as well as documents (currently or subsequently appended to the present specification) limiting the broadest scope of the claims of the present disclosure. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure. Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for gas demand information management based on smart gas, implemented by an Internet of Things (IoT) system for gas demand information management based on smart gas, wherein the IoT system for gas demand information management based on the smart gas comprises a gas user platform, a gas user service platform, a gas company management platform, a gas user object platform, and a gas equipment object platform, the method is executed by the gas company management platform, and the method comprises:
obtaining gas monitoring data from a plurality of channels based on the gas user platform, the gas user object platform, and the gas equipment object platform;
obtaining estimated demand data of a gas enterprise based on the gas user platform, wherein the estimated demand data include a plurality of future time periods and estimated demands corresponding to the plurality of future time periods;
generating a monitoring adjustment instruction and a data export instruction based on the gas monitoring data and the estimated demand data, and sending the monitoring adjustment instruction and the data export instruction to the gas user platform, the gas user object platform, and the gas equipment object platform, wherein the monitoring adjustment instruction includes upload frequencies and upload priorities of gas monitoring data of the plurality of channels, and the data export instruction includes at least one channel and a flow log file of a gas monitoring device corresponding to the at least one channel;
sending the data export instruction to the gas monitoring device corresponding to the at least one channel based on the gas user object platform, the gas equipment object platform, and/or the gas user platform; and
causing the gas monitoring device corresponding to the at least one channel to export, based on the data export instruction, the flow log file from a log storage unit to the gas user object platform, the gas equipment object platform, and/or the gas user platform.

2. The method of claim 1, wherein the method further comprises:
determining gas correction data and an allowable fluctuation range based on the gas monitoring data;
determining an anomalous channel based on the gas monitoring data, the allowable fluctuation range, a gas pressure, and a gas temperature;
determining a margin of error for the anomalous channel based on the gas monitoring data and the gas correction data;
generating, based on the margin of error, the gas pressure, and the gas temperature, an error correction instruction corresponding to each anomalous channel, and sending the error correction instruction to the gas user object platform, the gas equipment object platform, and/or the gas user platform;
in response to determining that the error correction instruction is to correct a metering parameter, sending the error instruction to a target channel based on the gas user object platform, the gas equipment object platform, and/or the gas user platform; and
causing a gas monitoring device corresponding to the target channel to automatically correct the metering parameter based on the error correction instruction.

3. The method of claim 2, wherein the determining the gas correction data and the allowable fluctuation range based on the gas monitoring data includes:
determining a grouping of the gas monitoring data of the plurality of channels based on the gas monitoring data through a first predictive model, wherein the first predictive model is a machine learning model; and
determining the gas correction data based on the grouping.

4. The method of claim 3, wherein an input of the first predictive model further includes feature vectors of the plurality of channels.

5. The method of claim 1, wherein the generating the monitoring adjustment instruction and the data export instruction based on the gas monitoring data and the estimated demand data includes:
determining an accuracy distribution based on the gas monitoring data and the estimated demand data; and
generating the monitoring adjustment instruction based on the accuracy distribution.

6. The method of claim 5, wherein the determining the accuracy distribution based on the gas monitoring data and the estimated demand data includes:
determining gas future data based on the gas correction data; and
determining the accuracy distribution based on the estimated demand data and the gas future data.

7. The method of claim 6, wherein the determining gas future data based on the gas correction data includes:
determining first future data by a second predictive model based on the gas correction data, the second prediction model being a machine learning model including a feature extraction layer and a first predictive layer, wherein the feature extraction layer is configured to determine a gas usage feature of the gas enterprise based on the gas correction data, time information, weather information, and enterprise type, and the first predictive layer is configured to determine the first future data based on the gas correction data, the estimated demand data, and the gas usage feature.

8. The method of claim 7, wherein the second predictive model further includes a second predictive layer, the second predictive layer is configured to determine second future data based on an enterprise association map, a node of the enterprise association map is the gas enterprise, and an edge of the enterprise association map include an upstream and downstream enterprise edge and a similar enterprise edge.

9. The method of claim 8, wherein a training process of the second predictive model includes:
determining different training sample sets and labels corresponding to the different training sample sets based on the enterprise type; and
alternating training the different training sample sets according to sizes of the different training sample sets, wherein a learning rate of each of the different training sample sets is adjusted based on a training sample feature.

10. An Internet of Things (IoT) system for gas demand information management based on smart gas, comprising gas demand information a gas user platform, a gas user service platform, a gas company management platform, a gas user object platform, and a gas equipment object platform, wherein:
the gas user platform interacts with the gas user service platform bi-directionally, and the gas user service platform interacts with the gas company management platform bi-directionally;
the gas user platform is configured to obtain gas monitoring data from a plurality of channels and estimated demand data from a gas enterprise, wherein the estimated demand data includes a plurality of future time periods and estimated demands corresponding to the plurality of future time periods;
the gas user object platform and the gas equipment object platform are configured to obtain the gas monitoring data from the plurality of channels;
the gas user object platform, the gas equipment object platform, and/or the gas user platform are further configured to send a data export instruction to a gas monitoring device corresponding to at least one channel and receive a flow log file of the monitoring device corresponding to the at least one channel; and
the gas company management platform is configured to:
generate a monitoring adjustment instruction and the data export instruction based on the gas monitoring data and the estimated demand data, and send the monitoring adjustment instruction and the data export instruction to the gas user platform, the gas user object platform and the gas equipment object platform, wherein the monitoring adjustment instruction includes upload frequencies and upload priorities of gas monitoring data of the plurality of channels, and the data export instruction includes at least one channel and the flow log file of the gas monitoring device corresponding to the at least one channel; and
in response to the gas monitoring device corresponding to the at least one channel receiving the data export instruction, cause the gas monitoring device to export, based on the data export instruction, the flow log file from a log storage unit to the gas user object platform, the gas equipment object platform, and/or the gas user platform.

11. The IoT system of claim 10, comprising a gas company sensing network platform, wherein the gas user object platform and the gas equipment object platform interact with the gas company management platform bi-directionally through the gas company sensing network platform.

12. The IoT system of claim 10, wherein the gas user object platform, the gas equipment object platform, and/or the gas user platform are further configured to:
receive an error correction instruction corresponding to an anomalous channel sent by the gas company management platform;
in response to determining that the error correction instruction is to correct a metering parameter, transmit the error instruction to a target channel;
the gas company management platform is further configured to:
determine gas correction data and an allowable fluctuation range based on the gas monitoring data;
determine the anomalous channel based on the gas monitoring data, the allowable fluctuation range, a gas pressure, and a gas temperature;
determine a margin of error of the anomalous channel based on the gas monitoring data and the gas correction data;
generate, based on the margin of error, the gas pressure, and the gas temperature, an error correction instruction corresponding to each anomalous channel, and send the error correction instruction to the gas user object platform, the gas equipment object platform, and/or the gas user platform; and
in response to the target channel receiving the error correction instruction, cause a gas monitoring device corresponding to the target channel to automatically adjust a metering parameter based on the error correction.

13. The IoT system of claim 12, wherein the gas company management platform is further configured to:
determine a grouping of the gas monitoring data of the plurality of channels based on the gas monitoring data through a first predictive model, the first predictive model being a machine learning model; and
determine the gas correction data based on the grouping.

14. The IoT system of claim 11, wherein the gas company management platform is further configured to:
determine an accuracy distribution based on the gas monitoring data and the estimated demand data; and
generate the monitoring adjustment instruction based on the accuracy distribution.

15. The IoT system of claim 14, wherein the gas company management platform is further configured to:
determine gas future data based on the gas correction data; and
determine the accuracy distribution based on the estimated demand data and the gas future data.

16. The IoT system of claim 15, wherein the gas company management platform is further configured to:
determine first future data by a second predictive model based on the gas correction data, the second prediction model being a machine learning model including a feature extraction layer and a predictive layer, wherein the feature extraction layer is configured to determine the first future data based on the gas correction data, time information, weather information, and enterprise type, to determine a gas usage feature of the gas enterprise, and the predictive layer is configured to determine the first future data based on the gas correction data, the estimated demand data, and the gas usage feature.

17. The IoT system of claim 16, wherein the second predictive model further includes a second predictive layer, the second predictive layer is configured to determine second future data based on an enterprise association map, a node of the enterprise association map is the gas enterprise, an edge of the enterprise association map include an upstream and downstream enterprise edge and a similar enterprise edge.

18. The IoT system of claim 17, wherein a training process of the second predictive model includes:
determining different training sample sets and labels corresponding to the different training sample sets based on the enterprise type; and
alternating training of the different training sample sets according to sizes of the different training sample sets, wherein a learning rate of each of the different training sample sets is adjusted based on a training sample feature.

19. A device for gas demand information management based on smart gas, comprising at least one memory and at least one processor, wherein the at least one memory is configured to store computer instructions, the at least one processor executes the computer instructions or part of the computer instructions to implement the method of claim 1.

20. A non-transitory computer-readable storage medium storing computer instructions, wherein when a computer reads the computer instructions in the storage medium, the computer performs the method of claim 1.
